(19) United States
(12) Patent Application Publication
(10) Pub. No.: US 2013/0093351 A1
(43) Pub. Date: Apr. 18, 2013

(54) WIRELESS REMOTE-CONTROLLED SEARCHLIGHT WITH DETACHABLE JUNCTION BOX

(71) Applicant: Shih-Yung CHIU, Sindian City (TW)

(72) Inventor: Shih-Yung CHIU, Sindian City (TW)

(21) Appl. No.: 13/271,361

(22) Filed: Oct. 12, 2011

(51) Int. Cl. H05B 37/02

(52) U.S. Cl. 315/291

(57) ABSTRACT

A wireless remote-controlled searchlight comprises a detachable junction box capable of being mounted onto or separated from the searchlight based on a user's own attempt, which detachable junction box comprises a PCB having a microcontroller and a RF receiver to input received RF signals transmitted from a wireless transmitter to the PCB; the searchlight is workable only if the detachable junction box mounted onto and electrically connected with the searchlight, but the searchlight is not workable and provides with function of anti-theft if the detachable junction box separated from the searchlight, and particularly the detachable junction box is portable so that the searchlight further provides with function of ease of maintenance or repair if the PCB or the RF receiver is out of order.

### BACKGROUND OF THE PRESENT INVENTION

1. Field of the Present Invention

The invention relates to a wireless remote-controlled searchlight, and more particularly to a wireless remote-controlled searchlight with a detachable junction box for anti-theft and ease of maintenance or repair.

2. Description of Prior Art

As shown in FIG. 1, a prior used RF (radio frequency) wireless remote-controlled searchlight 10 is capable of changing the illumination angle in vertical and horizontal direction, which at least comprises a lamp seat 11 for illumination or lighting, a base seat 12 pivotally connected to the bottom side of the lamp seat 11, a RF receiver 13 installed outside to receive identification codes and RF signals transmitted from a wireless transmitter 90, a controlled PCB (printed circuit board, not shown in drawings) installed inside the base seat 12 to control the searchlight to be lighten and changed illumination angle and a power cord 75 for power supply.

Through the RF receiver 13 inputs the received RF signals transmitted from a wireless transmitter 90 to the controlled PCB, a user can turn on or turn off the searchlight 10 by pushing the lamp power switch SW5 designed on the wireless transmitter 90 or adjust the illumination angle of lighting emitted from the searchlight 10 by pushing the direction control switch SW1, SW2, SW3 and SW4 designed on the wireless transmitter 90.

However, due to the controlled PCB or the RF receiver 13 not portable or detachable from the searchlight 10, prior used RF wireless remote-controlled searchlight 10 is not provided with function of anti-theft, And, under harsh climate the controlled PCB of the searchlight 10 is apt to out of order due to moisture and particularly the searchlight 10 is also hard to maintenance or repair since the controlled PCB is not easily detachable from the searchlight 10.

### SUMMARY OF THE INVENTION

Therefore, the main object of the present invention is to disclose a wireless remote-controlled searchlight provided with a detachable junction box capable of being mounted onto or separated from the searchlight based on a user's own attempt for anti-theft and ease of maintenance or repair.

The wireless remote-controlled searchlight in addition to the detachable junction box further comprises a lamp housing provided with a cable connector for electrical connection or disconnection with the detachable junction box, a lamp means pivotally mounted on the lamp housing, a base means securely mounted with a stationary gear and pivotally mounted with the lamp housing; a vertical drive means mounted on the lamp housing for vertically driving the lamp means moved in tilt movement, and a horizontal drive means mounted on the lamp housing for horizontally driving the lamp means and the lamp housing rotated in pan movement.

The detachable junction box is a drawer-like box having a connector means extended outside for electrical connection with the cable connector of the lamp housing and a printed circuit board (PCB) installed inside, wherein the connector means is a socket or a plug which contains a power terminal for 12-volt DC power input, a lamp-power terminal for 12-volt DC power output, a tilt-driven power terminal for 12-volt DC power output, and a pan-driven power terminal for 12-volt DC power output, and wherein the PCB comprises a RF receiver to receive identification codes and RF signals transmitted from a separated wireless transmitter; a MCU to output a power on/off controlling signal, a tilting controlled signal or a panning controlled signal according to the corresponding received RF signals input from the RF receiver; a current voltage regulator in parallel electrically connected with the power terminal of the connector means to convert an input 12-volt DC power into a 5-volt DC power required by the MCU and the RF receiver; a relay actuated circuit normally kept in open circuit which input end in parallel electrically connected with the power terminal of the connector means and the output end electrically connected with the lamp-power terminal of the connector means, and the relay actuated circuit becomes in close circuit only if a related power on/off controlling signal had output from the MCU to control the relay actuated circuit; and a motor actuated circuit normally kept in open circuit comprising an input end in parallel electrically connected with the power terminal of the connector means and two separated output ends one independently connected with the tilt-driven power terminal and the other one independently connected with the pan-driven power terminal of the connector means, and one or both of the two separated output ends become in close circuit only if a related tilting controlled signal or/and a panning controlled signal had output from the MCU to control the motor actuated circuit.

The searchlight is workable only if the detachable junction box mounted onto and electrically connected with the cable connector of the lamp housing of the searchlight, but the searchlight is not workable and provides with function of anti-theft if the detachable junction box separated from the searchlight, and particularly the detachable junction box is portable so that the searchlight further provides with function of ease of maintenance or repair if the PCB or the RF receiver is out of order.

### BRIEF DESCRIPTION OF THE DRAWINGS

FIG. 1 is a schematic drawing of a prior used RF wireless remote-controlled searchlight;

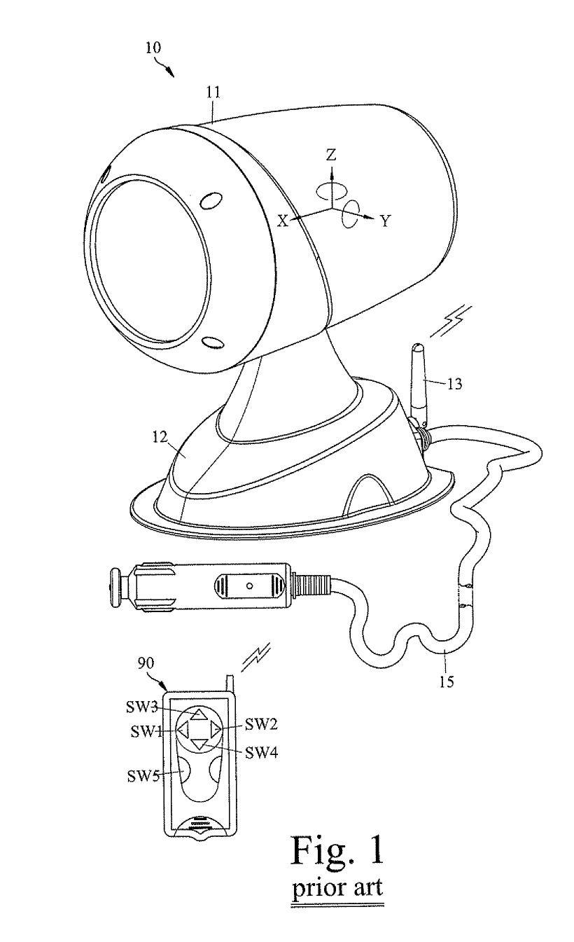

FIG. 2 is a partial cross sectional view of the invented searchlight according to the present invention;

FIG. 3 is an illustrating drawing to illustrate the invented searchlight according to the present invention provides with a detachable junction box for the purpose of anti-theft and ease of maintenance or repair;

FIG. 4 is a partially exploded view of the invented searchlight according to the present invention;

FIG. 5 is a schematic drawing viewed from top of the invented searchlight according to the present invention;

FIG. 6 is a schematic circuit diagram of the detachable junction box electrical connection with a cable connector shown in FIG. 2 and a separated portable wireless transmitter according to the present invention for depicting the relation between components and the position of each component.

### DESCRIPTION OF THE PREFERRED EMBODIMENT

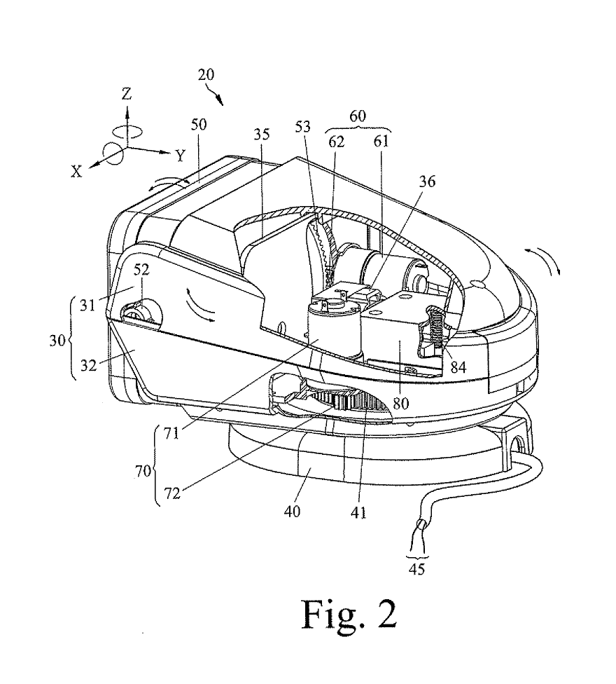

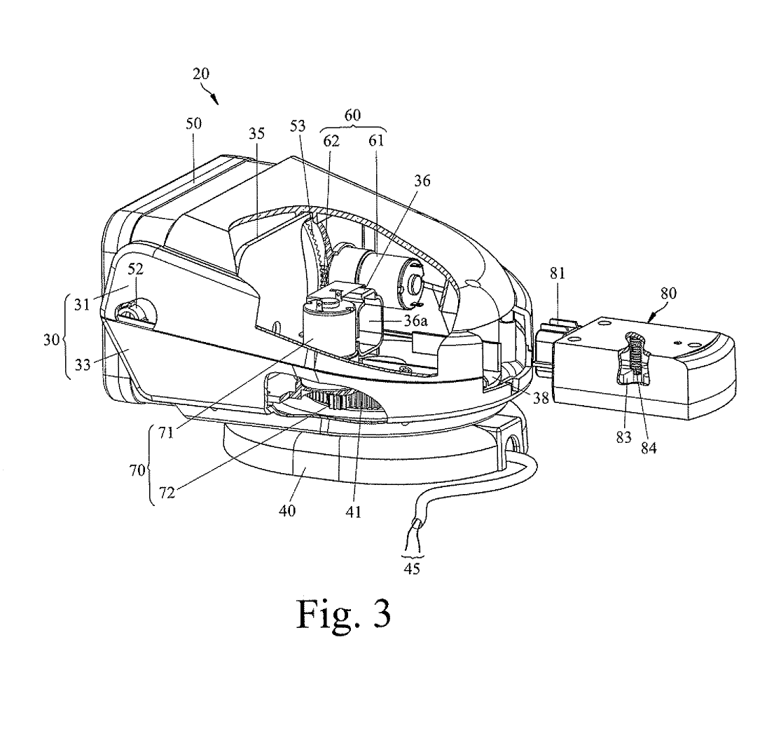

Referring to FIGS. 2 and 3, the preferred embodiment of a wireless remote-controlled searchlight 20 of the present invention is permanently positioned on the roof of a vehicle or the deck of a boat, which comprises a lamp housing 30, a base means 40, a lamp means 50, a vertical drive means 60, a horizontal drive means 70, a detachable junction box 80 with a RF receiver 84 assembled inside, and a separated portable wireless transmitter 90.

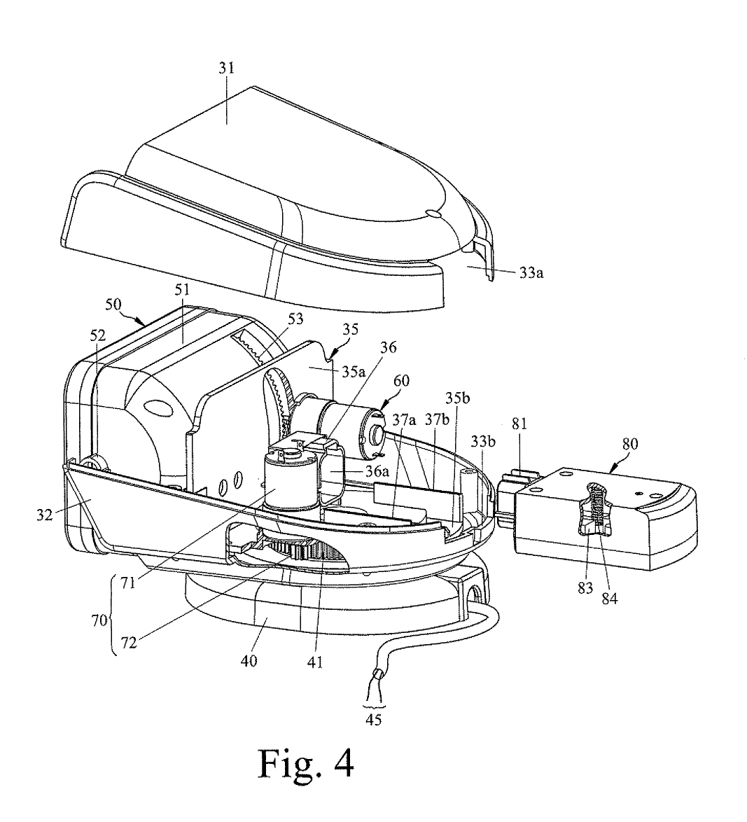

Referring to FIGS. 3 and 4, the lamp housing 30 is constituted by an upper housing 31 and a lower housing 32. The upper housing 31 has a first groove 33a formed on rear end, and the lower housing 32 has a second groove 33b formed on rear end and corresponded to the first groove 33a, so that the lamp housing 30 after completely assembled has a slot 38 constituted by the first groove 33a and the second groove 33b. Accordingly, the detachable junction box 80 is capably mounted onto or separated from the lamp housing 30 through the slot 28.

The lower housing 32 further has a partition plate 35 securely amounted within the interior of the lower housing 32. The partition plate 35 comprises a vertical part 35a and a horizontal part 35b, wherein the vertical part 35a is to partition off part of the spaces of the lower housing 32 as a lamp-room for pivotally mounted the lamp means 50 as well as to provide for the vertical drive means 60 fixedly mounted thereon, and wherein the horizontal part 35b is to provide with a cable connector 36 as well as the horizontal means 70 fixedly mounted thereon. In addition, the horizontal part 35b may further have a pair of parallel guide-plates 37a and 37b mutually formed in front of the cable connector 36 as a guided channel which is opposite to the above-mentioned slot 28 of lamp housing 30 for sake of accurate assembly or disassembly of the detachable junction box 80.

Referred to from FIG. 2 to FIG. 6, the cable connector 36 is designed for electrical connection or disconnection with the detachable junction box 80. The cable connector 36 has a socket (or plug) 36a provided with four separated sets of male (or female) terminals including one set of power terminal connected with a 12-volt DC current leads 45 for power supply and three sets of current output terminals wherein one is a lamp-power terminal provided for electrical connection with the lamp means 50 through current leads 45a, the other one is a tilt-driven power terminal provided for electrical connection with the vertical drive means 60 through current leads 46 and another one is a pan-driven power terminal provided for electrical connection with the horizontal drive means 70 through current leads 47 respectively.

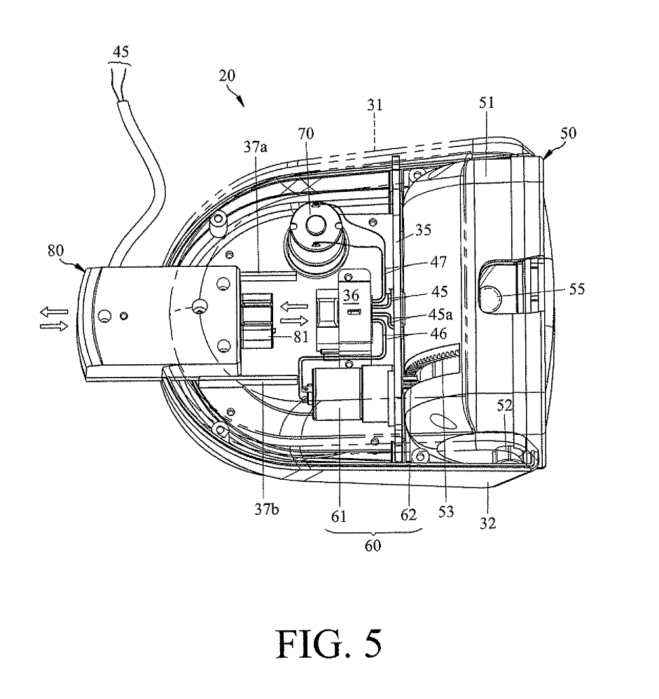

Further referring to FIGS. 4 and 5, the lamp means 50 includes a bulb housing 51 with a bearing means 52 pivotally mounted in the lamp housing 30 for vertical tilt movement, the bulb housing 51 further has a vertical gear member 53 integrally formed on back of the bulb housing 51. The lamp means 50 has a bulb 55 installed thereon to let the bulb 55 through the current leads 45a be electrically connected to the lamp-power terminal of the cable connector 36 of lamp housing 30.

The vertical drive means 60 is mounted on the vertical part 35a of the partition plate 35 of the lamp housing 30 for vertically driving the lamp means 50 pivotally rotated in tilt movement, which includes a reversible gear motor 61 having an output shaft with a pinion means 62 for engaging with the vertical gear member 53 of the lamp means 50. And, the reversible gear motor 61 is connected with leads 46 which are electrically connected to the tilt-driven power terminal of the cable connector 36 of lamp housing 30.

As shown in FIGS. 2 and 5, when the vertical drive means 60 is driven with electricity through leads 46, the lamp means 50 is pivotally rotated in tilt movement.

The base means 40 securely mounted with a stationary gear 41 is pivotally mounted with the lamp housing 30 and allows the stationary gear 41 engaged with the horizontal drive means 70 which is fixedly mounted on the horizontal part 35b of the partition plate 35 of the lamp housing 30.

The base means 40 is fastened onto an auxiliary part (not shown in drawings) which has a flange extended from its bottom and plural fasten holes formed on the flange applied for permanently mounting the base means 40 by means of screws to the roof of a vehicle or the deck of a boat.

The horizontal drive means 70 is mounted on the horizontal part 35b of the partition plate 35 of the lamp housing 30 for horizontally driving the lamp means 50 and the lamp housing 30 rotated in pan movement, which includes a reversible gear motor 71 having an output shaft with a pinion means 72 for engaging with the stationary gear 41 of the base means 40. And, the reversible gear motor 71 is connected with leads 47 which are electrically connected to the pan-driven power terminal of the cable connector 36 of lamp housing 30.

As shown in FIGS. 2 and 5, when the horizontal drive means 70 is driven with electricity through leads 47, the lamp means 50 and lamp housing 30 are together rotated in horizontal pan movement less than 360 degrees.

Referred to from FIG. 2 to FIG. 6, the detachable junction box 80 is a drawer-like box having a plug (or socket) 81 designed for electrical connection or disconnection with the socket (or plug) 36a of the cable connector 36. Accordingly, the plug 81 of the detachable junction box 80 has four separated sets of female (or male) terminals, namely, a power terminal, a lamp-power terminal, a tilt-driven power terminal and a pan-driven power terminal, each is correspondingly related to that of male (or female) terminals of the socket 36a of the cable connector 36 for electrical connection.

The detachable junction box 80 further has a printed circuit board (PCB) which comprises a current voltage regulator 82, a microcontroller (MCU) 83 with ROM or EEPROM, a RF receiver 84, a relay actuated circuit 85 and a motor actuated circuit 86 formed thereon.

The current voltage regulator 82 which is in parallel electrically connected with the power terminal of the plug 81 is adapted to convert 12-volt DC power source current supplied from the current leads 45 into a 5-volt DC current power which is required by the MCU 83, the ROM or EEPROM and the RF receiver 84.

The RF receiver 84 is installed on the PCB inside the detachable junction box 80, which function is to receive the identification code and the RF signal transmitted from a wireless transmitter 90 and subsequently send the received identification code and RF signal to the input port of the MCU 83.

The MCU 83 is an IC component that independently carries out specific control functions and integrates related circuits for the central processing unit (CPU), read-on memory (ROM) or electrically erasable programmable read-on memory (EEPROM), random access memory, I/O control circuit and CTC timer on a single chip.

Since the ROM or EEPROM of the MCU 83 contains the information of the identification code and the corresponding decoding for the received RF control signals transmitted from the wireless transmitter 90, therefore, after the identification code received by the receiver 84 is confirmed, the MCU 83 will base on the input corresponding received RF signals and the decoded corresponding control signals to output a corresponding controlling signal to the relay actuated circuit 85 or the motor actuated circuit 86, or both.

The relay actuated circuit 85 is one end in parallel electrically connected with the power terminal of the plug 81 and the other end electrically connected with the lamp-power terminal of the plug 81. The relay actuated circuit 85 is to become either in open circuit or in close circuit only if a related power on/off controlling signal had output from the MCU 83 to control the relay actuated circuit 85.

Since the relay actuated circuit 85 is functioned to normally keep in open circuit, the 12-volt DC power source current if supplied from the current leads 45 still can not be reached to the lamp-power terminal of the plug 81.

Similarly, the motor actuated circuit 86 is one end in parallel electrically connected with the power terminal of the plug 81 and has two separated outputs one independently connected with the tilt-driven power terminal and the other one independently connected with the pan-driven power terminal of the plug 81. One or both of the two separated outputs of the motor actuated circuit 86 is to become either in open circuit or in close circuit only if a related tilting controlled signal or/and a rotating controlled signal had output from the MCU 83 to control the motor actuated circuit 86.

Since the motor actuated circuit 86 is functioned to normally keep in open circuit, the 12-volt DC power source current if supplied from the current leads 45 still can not be reached to the tilt-driven power terminal or/and the pan-driven power terminal of the plug 81.

It is known the wireless remote-controlled searchlight 20 of the present invention is not workable if the detachable junction box 80 is separated from the lamp housing 30 for electrical disconnection with the cable connector 36 of the lamp housing 30. Accordingly, when a user takes the detachable junction box 80 away from the wireless remote-controlled searchlight 20 of the present invention, the wireless remote-controlled searchlight 20 is therefore provided with function of anti-theft.

Moreover, the wireless remote-controlled searchlight 20 of the present invention is, if detachably taken away the detachable junction box 80, almost no more PCB or electronic components fixedly installed inside, so that in the harsh climate the wireless remote-controlled searchlight 20 of the present invention is provided with function of prevention from PCB or electronic components out of order due to moisture.

And, since it is so freely and easily maintainable or repairable to the PCB of the detachable junction box 80, the wireless remote-controlled searchlight 20 of the present invention if the PCB is failed is provided with function of easy maintenance or repair.

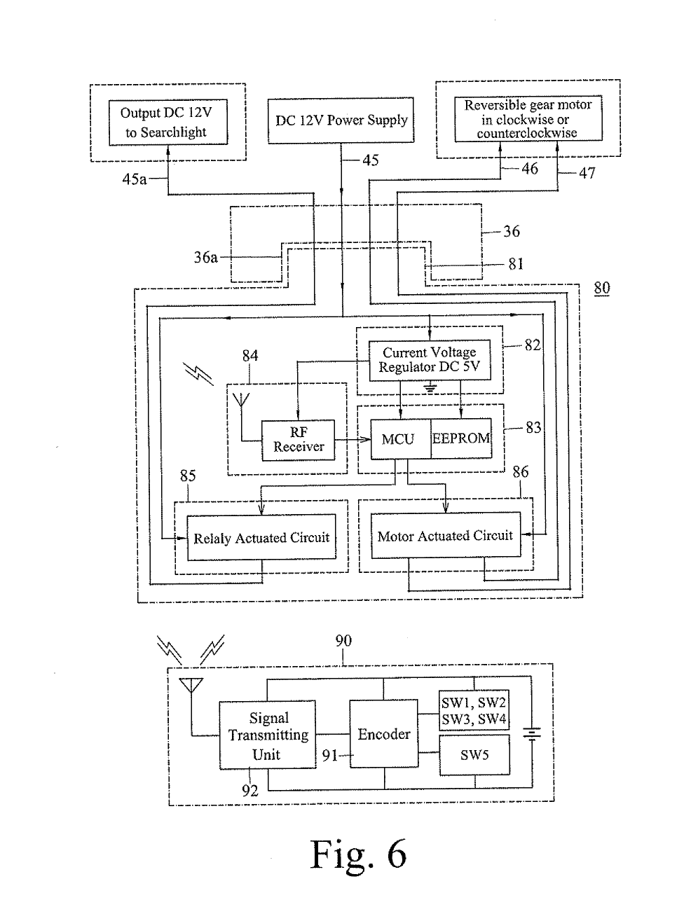

As shown in FIG. 6, the separated portable wireless transmitter 90 includes a four-way directional control switch SW1, SW2, SW3 and SW4, an on/off switch SW5, an encoder 91 and a signal transmitting unit 92, and the power for the wireless transmitter 90 is supplied by a replaceable internal power supply, e.g. a 9-volt battery.

When any one of switches of SW1, SW2, SW3, SW4 and SW5 of the wireless transmitter 90 is pressed, an identification code with corresponding RF (radio frequency) signal information is generated from the encoder 91 and further transmitted out through the signal transmitting unit 92 by surface acoustic waves (SAW). It is meant the wireless transmitter 90 is capable of sending out the RF control signals including a Power On/Off controlled RF signal by pressing the switch SW5, a lamp tilting in vertical direction controlled RF signal by pressing the switch SW3 or SW4, and a lamp rotating in a horizontal direction controlled RF signal by pressing the switch SW1 or SW2.

Referred to FIGS. 3 and 5, when a user wants to use the wireless remote-controlled searchlight 20 of the present invention, the user inserts the detachable junction box 80 owned by the user into the lamp housing 30 through the slot 38 thereof, and then the detachable junction box 80 is guided with the guide-plates 37a and 37b of the lamp housing 30 to have the plug 81 of the detachable junction box 80 precisely jointed with the socket 36a of the cable connector 36 of the lamp housing 30 for electrical connection.

As shown in FIG. 6, by wireless remotely control, while the receiver 84 of the detachable junction box 80 is received the Power On/Off controlled RF signal transmitted from the wireless transmitter 90 controlled by the user, the relay actuated circuit 85 of the detachable junction box 80 if controlled by the MCU 83 thereof is in close circuit, a 12-volt DC power source current supplied from the current leads 45 is input to the power terminal of the plug 81 and reached to the lamp-power terminal of the plug 81 and further to the cable connector 36 of lamp housing 30 to illuminate the bulb 55 of the lamp means 50 through the current leads 45a for searchlight. Otherwise, the bulb 55 of the lamp means 50 is not illuminated when the relay actuated circuit 85 is further controlled by the MCU 83 to be in open circuit.

Further, while the receiver 84 is received the lamp tilting in vertical direction or rotating in a horizontal direction controlled RF signal transmitted from the wireless transmitter 90 by wireless remotely control, it is meant either the reversible gear motor 61 of vertical drive means 60 shall be actuated for vertically driving the lamp means 50 or the reversible gear motor 71 of horizontal drive means 60 shall be actuated for horizontally driving both the lamp housing 30 and the lamp means 50, according to the fact if the motor actuated circuit 86 is to have the input 12-volt DC power supplied from the leads 45 to be controllably reached to the tilt-driven power terminal or/and the pan-driven power terminal of the plug 81 and output to the corresponding tilt-driven power terminal or/and the pan-driven power terminal of the cable connector 36. Therefore, if the output 12-volt DC power is controllably though the leads 46 reached to the reversible gear motor 61 of vertical drive means 60, the lamp means 50 is tilted in vertical direction, or if the output 12-volt DC power is controllably though the leads 47 reached to the reversible gear motor 71 of horizontal drive means 70, the lamp means 50 is panned in horizontal direction.

Accordingly, while the vehicle or the boat is parked, the user may have the detachable junction box 80 mounted onto the lamp housing 30 for searchlight by wireless remotely control or separated from the lamp housing 30 and portably taken away for anti-theft, maintenance of repair.

What is claimed is:

1. A wireless remote-controlled searchlight comprising:
a detachable junction box having a connector means extended outside for electrical connection and a printed circuit board (PCB) installed inside, wherein the connector means is a socket or a plug which contains a power terminal for 12-volt DC power input, a lamp-power terminal for 12-volt DC power output, a tilt-driven power terminal for 12-volt DC power output, and a pan-driven power terminal for 12-volt DC power output, and wherein the PCB comprises
a RF receiver to receive identification codes and RF signals transmitted from a separated wireless transmitter;
a MCU to output a power on/off controlling signal, a tilting controlled signal or a panning controlled signal according to the corresponding received RF signals input from the RF receiver;
a current voltage regulator in parallel electrically connected with the power terminal of the connector means to convert an input 12-volt DC power into a 5-volt DC power required by the MCU and the RF receiver;
a relay actuated circuit normally kept in open circuit which input end in parallel electrically connected with the power terminal of the connector means and the output end electrically connected with the lamp-power terminal of the connector means, and the relay actuated circuit becomes in close circuit only if a related power on/off controlling signal had output from the MCU to control the relay actuated circuit; and
a motor actuated circuit normally kept in open circuit comprising an input end in parallel electrically connected with the power terminal of the connector means and two separated output ends one independently connected with the tilt-driven power terminal and the other one independently connected with the pan-driven power terminal of the connector means, and one or both of the two separated output ends become in close circuit only if a related tilting controlled signal or/and a panning controlled signal had output from the MCU to control the motor actuated circuit;
a lamp housing comprising a slot for the detachable junction box capably mounted onto or separated from the lamp housing through the slot; and the lamp housing constituted by an upper housing and a lower housing having a partition plate comprising a vertical part to partition off part of the spaces of the lower housing as a lamp-room and a horizontal part provided for a cable connector mounted thereon, wherein the cable connector has a coupling means for electrical connection or disconnection with the corresponding connector means of the detachable junction box, which coupling means contains a power terminal connected with a 12-volt DC current leads for power supply, a lamp-power terminal for 12-volt DC power input, a tilt-driven power terminal for 12-volt DC power input, and a pan-driven power terminal for 12-volt DC power input;
a lamp means pivotally mounted into the lamp-room of the lamp housing for vertical tilt movement, comprising a bulb housing with a bulb connected by leads with the lamp-power terminal of the coupling means of the cable connector and a vertical gear member integrally formed on back of the bulb housing;
a base means securely mounted with a stationary gear and pivotally mounted with the lamp housing;
a vertical drive means mounted on the vertical part of the partition plate of the lamp housing for vertically driving the lamp means, which includes a reversible gear motor connected by leads with the tilt-driven power terminal of the coupling means of the cable connector of the lamp housing and an output shaft with a pinion means engaged with the vertical gear member of the lamp means; and
a horizontal drive means mounted on the horizontal part of the partition plate of the lamp housing for horizontally driving the lamp means and the lamp housing rotated in pan movement, which includes a reversible gear motor connected by leads with the pan-driven power terminal of the cable connector of lamp housing and an output shaft with a pinion means engaged with the stationary gear of the base means.

2. The wireless remote-controlled searchlight as defined in claim 1, wherein the horizontal part of the partition plate of the lamp housing further have a pair of parallel guide-plates as a guided channel for accurate assembly or disassembly of the detachable junction box.
